(19) United States
(12) Patent Application Publication
(10) Pub. No.: US 2019/0243349 A1
(43) Pub. Date: Aug. 8, 2019

(54) ANOMALY ANALYSIS METHOD, PROGRAM, AND SYSTEM

(71) Applicant: NEC Corporation, Minato-ku, Tokyo (JP)

(72) Inventor: Masashi FUJITSUKA, Tokyo (JP)

(73) Assignee: NEC Corporation, Minato-ku, Tokyo (JP)

(21) Appl. No.: 16/344,529

(22) PCT Filed: Nov. 7, 2016
(86) PCT No.: PCT/JP2016/004819

§ 371 Date: Apr. 24, 2019

(51) Int. Cl. G05B 23/02; H04Q 9/00

(52) U.S. Cl. CPC G05B 23/0243; H04Q 2209/10; H04Q 9/00

(57) ABSTRACT

The present invention provides anomaly analysis method, program, and system that require less labor for introduction and facilitate determination of a true factor of an anomaly. An anomaly analysis system 100 according to one example embodiment of the present invention includes a main-factor extraction unit 120 that, based on measurement values measured by a plurality of sensors provided in a facility, extracts a sensor corresponding to a main factor that influences the measurement values; and a sub-factor correction unit 130 that generates a model indicating a normal state of the facility by using a value indicating a sub-factor that influences the measurement values in addition to the measurement values measured by the sensors corresponding to the main factor. The value indicating the sub-factor is measured by a scheme different from the sensors.

### TECHNICAL FIELD

The present invention relates to an anomaly analysis method, an anomaly analysis program, and an anomaly analysis system that analyze an anomaly by using measurement values of sensors.

### BACKGROUND ART

In factories (plants), production facilities are often operated by using fuel such as petroleum, coal, natural gas as an energy source. In general, various types of sensors that measure a temperature, a pressure, a flowrate, or the like are provided in a facility, and measurement values of the sensors are monitored by a monitoring system. When an anomaly is detected in measurement values in the sensors, it is requested to promptly analyze the factor of the anomaly and solve the factor.

The fuel used in the operation of a facility has different compositions depending on a production place or a production time. Thus, when fuel is replaced, the tendency of measurement values of sensors changes around the time of the replacement even with the same type of fuel being used. Since the difference in the composition of fuel is often not a direct cause of an anomaly, it is desirable to perform anomaly analysis excluding the influence of such a difference. When the cause of an anomaly is analyzed without consideration on a sub-factor such as a difference in fuel, since influences of a true factor and a sub-factor of an anomaly are mixed and included in the measurement values of the sensors, it may be difficult to identify the true factor.

The technology disclosed in Patent Literature 1 generates a model by using numerical analysis data generated by simulating design and operation conditions of a plant and performing numerical analysis on a plurality of fuel compositions in addition to operation result data accumulated for each production area of fuel. With a use of such a model, it is possible to control a facility taking an influence due to a difference in fuel into consideration.

### CITATION LIST

### Patent Literature

PTL 1: Japanese Patent Application Laid-Open No. 2007-271187

### SUMMARY OF INVENTION

### Technical Problem

In the technology disclosed in Patent Literature 1, however, it is necessary to perform numerical analysis for various fuel compositions in advance and accurately set design and operation conditions or the like of a plant before the numerical analysis. Thus, large labor may be needed for introducing the technology.

The present invention has been made in view of the above problem and intends to provide an anomaly analysis method, an anomaly analysis program, and an anomaly analysis system that facilitate determination of a true factor of an anomaly and require less labor for introduction.

### Solution to Problem

A first example aspect of the present invention is an anomaly analysis method including: based on measurement values measured by a plurality of sensors provided in a facility, extracting a sensor corresponding to a main factor that influences the measurement values; and generating a model indicating a normal state of the facility by using a value indicating a sub-factor that influences the measurement values in addition to the measurement values measured by the sensors corresponding to the main factor, and the value indicating the sub-factor is measured by a scheme different from the sensors.

A second example aspect of the present invention is an anomaly analysis program that causes a computer to perform: based on measurement values measured by a plurality of sensors provided in a facility, extracting a sensor corresponding to a main factor that influences the measurement values; and generating a model indicating a normal state of the facility by using a value indicating a sub-factor that influences the measurement values in addition to the measurement values measured by the sensors corresponding to the main factor, and the value indicating the sub-factor is measured by a scheme different from the sensors.

A third example aspect of the present invention is an anomaly analysis system including: a main-factor extraction unit that, based on measurement values measured by a plurality of sensors provided in a facility, extracts a sensor corresponding to a main factor that influences the measurement values; and a sub-factor correction unit that generates a model indicating a normal state of the facility by using a value indicating a sub-factor that influences the measurement values in addition to the measurement values measured by the sensors corresponding to the main factor, and the value indicating the sub-factor is measured by a scheme different from the sensors.

### Advantageous Effects of Invention

According to the present invention, since a main factor is extracted from measurement values of the sensors and a model corrected by using a sub-factor in addition to the extracted main factor is generated, first, the main factor can be analyzed taking the influence of the sub-factor into consideration in anomaly analysis, and thus determination of the true factor is facilitated. Further, since analysis is performed by using measurement values of the sensors and a value indicating the sub-factor, it is not necessary to perform numerical analysis based on design and operation conditions or the like of the plant, which results in less labor in introduction.

### BRIEF DESCRIPTION OF DRAWINGS

FIG. 1 is a diagram illustrating graphs of an exemplary fuel value and an exemplary sensor value.

FIG. 2 is a block diagram of an anomaly analysis system according to an example embodiment.

FIG. 3 is a schematic configuration diagram of the anomaly analysis system according to the example embodiment.

FIG. 4 is a diagram illustrating a flowchart of an anomaly analysis method according to the example embodiment.

FIG. 5 is a diagram illustrating a flowchart of a main-factor extraction process according to the example embodiment.

FIG. 6 is a diagram illustrating a flowchart of a sub-factor correction process according to the example embodiment.

FIG. 7 is a block diagram of the anomaly analysis system according to the example embodiment.

### DESCRIPTION OF EMBODIMENTS

While an example embodiment of the present invention will be described below with reference to the drawings, the present invention is not limited to the present example embodiment. Note that, in the drawings described below, components having the same function are labeled with the same references, and repeated description thereof may be omitted.

### Example Embodiment

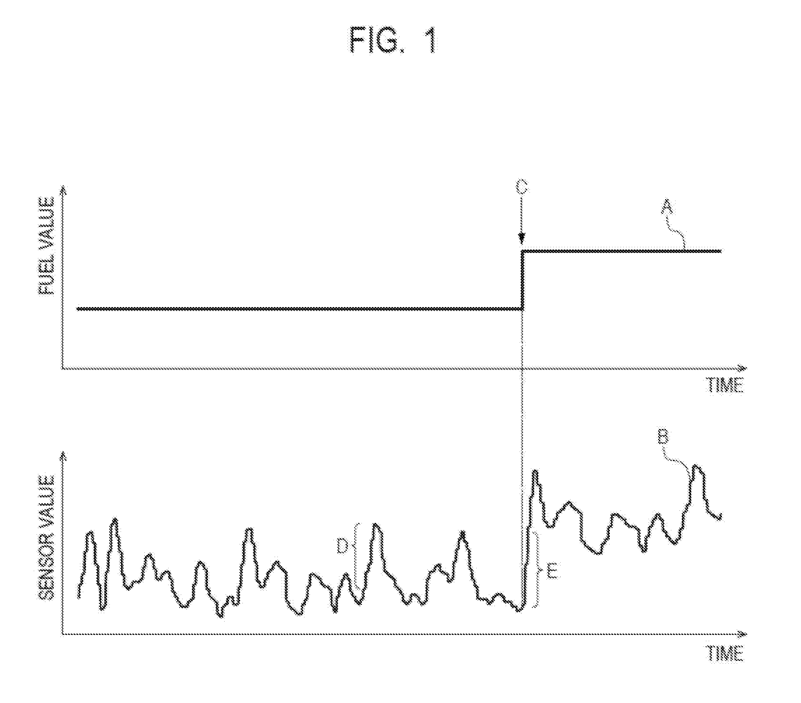

FIG. 1 is a diagram illustrating a graph A of an exemplary fuel value and a graph B of an exemplary sensor value. In the graph A of the fuel value, the horizontal axis represents time (arbitrary unit), and the vertical axis represents a fuel value (arbitrary unit). The fuel value is a numerical value representing characteristics of a fuel, which is an element content of hydrogen, carbon, nitrogen, oxygen sulfur, or the like, a moisture, a hygroscopic moisture, a calorific value, a grindability, a fuel ratio, or the like when coal is used as fuel, for example. The graph A represents any one exemplary type of fuel values.

In the graph B of the sensor value, the horizontal axis represents time (arbitrary unit), and the vertical axis represents a sensor value (arbitrary unit). The sensor value is a value measured by a sensor, and the sensor is a temperature sensor, a pressure sensor, or an air volume sensor provided at a predetermined position in a facility operated using fuel, for example. The graph B represents an any one exemplary type of sensor values. In FIG. 1, the time on the horizontal axis is the same for the graph A and the graph B.

In the graph A, the fuel value changes around a certain point of time C. Such a discrete change may occur when fuel of one production area is replaced with fuel of another production area, for example. This is because, even with the same type of fuel, the composition of fuel may be different depending on the production place or the production time thereof and the fuel value such as an element content or the like described above may vary.

In the graph B, the sensor value changes with time. Such a time-series change D is formed multiply due to some factors or an error. In anomaly analysis, it is determined that there is an anomaly when the time-series change D in the graph B deviates from a state (model) considered as normal exceeding a predetermined reference. An element that directly causes an anomaly is here referred to as a main factor in particular. A main factor may be deterioration of a facility, deposition of a substance, or the like.

In the graph B, the tendency of the sensor value changes at the point of time C at which the fuel value changes. Such a change E in tendency is caused by the change of the fuel value. However, most changes of the fuel value do not directly cause an anomaly. An element that is not a direct cause of an anomaly (the fuel value in this example) is referred to as a sub-factor in particular. Since a sub-factor may prevent determination of a main factor that causes an anomaly in anomaly analysis, it is desirable that the sub-factor be removed.

Conventionally, to remove an influence of disturbance to the sensor value, regression analysis may be used. In such a case, regression is performed by using the sensor value as an objective variable and using disturbance as an explanatory variable. Then, a model can be generated by removing the influence of disturbance obtained as a result of regression from the sensor value. In the situation where the fuel value is not a main factor causing variation of the sensor value, however, mere regression by using the fuel value as an explanatory variable may result in a likelihood that appropriate regression is unable to be performed due to the presence of another main factor. Thus, even with a use conventional mere regression, an influence of a sub-factor (fuel value) cannot be appropriately removed in anomaly analysis.

In contrast, according to the present example embodiment, in a main-factor extraction process and a sub-factor correction process described later, the presence of a main factor and a sub-factor is considered to perform more accurate regression than before, and thereby an influence of a sub-factor on a model can be reduced.

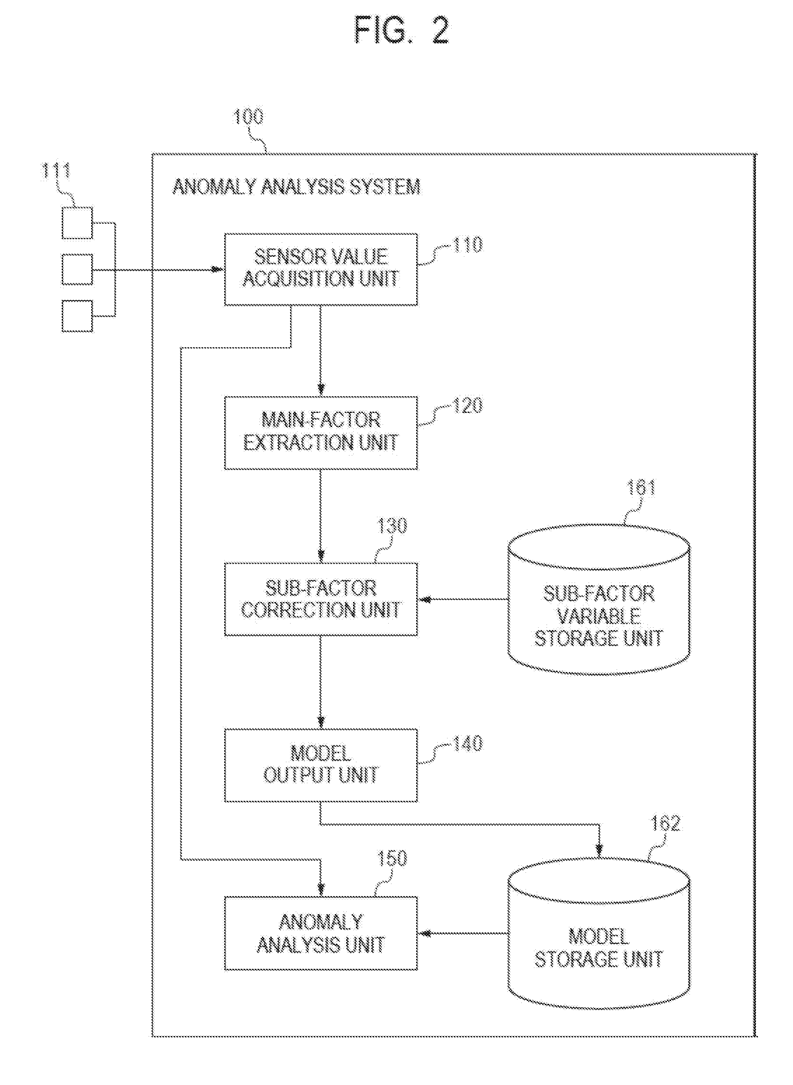

FIG. 2 is a block diagram of an anomaly analysis system 100 according to the present example embodiment. In FIG. 2, arrows represent main dataflows, and there may be other dataflows than those illustrated in FIG. 2. In FIG. 2, each block illustrates a configuration in a unit of function rather than in a unit of hardware (device). Therefore, the block illustrated in FIG. 2 may be implemented in a single device or may be implemented separately in a plurality of devices. Transmission and reception of the data between blocks may be performed via any member, such as a data bus, a network, a portable storage medium, or the like.

The anomaly analysis system 100 includes, as a processing unit, a sensor value acquisition unit 110, a main-factor extraction unit 120, a sub-factor correction unit 130, a model output unit 140, and an anomaly analysis unit 150. Further, the anomaly analysis system 100 includes, as a storage unit, a sub-factor variable storage unit 161 and a model storage unit 162.

The sensor value acquisition unit 110 acquires information indicating time-series measurement values (sensor values) measured by two or more sensors 111 provided in a facility to be analyzed. The sensor value acquisition unit 110 may sequentially receive sensor values from the sensors 111 or may collectively receive sensor values measured in a predetermined time period. Further, the sensor value acquisition unit 110 may read sensor values received from the sensors 111 and stored in the anomaly analysis system 100 in advance. The sensors 111 are any sensors such as a temperature sensor, a pressure sensor, an air volume sensor, or the like. The sensors 111 may include one or multiple types of sensors, or the same type of sensors may be provided in a plurality of places. Each of the sensors 111 is identified and managed in accordance with the type and the installation place thereof.

The main-factor extraction unit 120 performs a main-factor extraction process described later on sensor values acquired by the sensor value acquisition unit 110 and thereby extracts one or more sets of the sensors 111 as corresponding to a main factor.

The sub-factor correction unit 130 generates a model corrected by a sub-factor by using a variable (value) indicating a sub-factor pre-stored in the sub-factor variable storage unit 161 to perform a sub-factor correction process described later on the set of sensors 111 corresponding to a main factor extracted by the main-factor extraction unit 120. The variable indicating a sub-factor is measured in advance by a scheme different from a use of the sensors 111 and stored in the sub-factor variable storage unit 161 as time-series data. In the present example embodiment, a fuel value is used as a variable indicating a sub-factor. The fuel value may be, for example, an element content of hydrogen, carbon, nitrogen, oxygen, sulfur, or the like, a moisture, a hygroscopic moisture, a calorific value, a grindability, a fuel ratio, or the like in the fuel, which is measured by performing industry analysis or the like on the fuel. The variable indicating a sub-factor may be represented in any data form (file form), which may be binary data or text data, for example. Further, a variable indicating a sub-factor may be stored in the sub-factor variable storage unit 161 as a binary file or a text file or may be stored in the sub-factor variable storage unit 161 as a table in a database.

The model output unit 140 outputs a correction model corrected by the sub-factor correction unit 130 and stores the output correction modes in the model storage unit 162. The correction model may be represented by any data form (file form), for example, which may be binary data or text data. Further, the correction model may be stored in the model storage unit 162 as a binary file or a text file or may be stored in the model storage unit 162 as a table in a database.

The anomaly analysis unit 150 compares sensor values acquired by the sensor value acquisition unit 110 with the correction model stored in the model storage unit 162 and thereby analyzes a factor related to an anomaly.

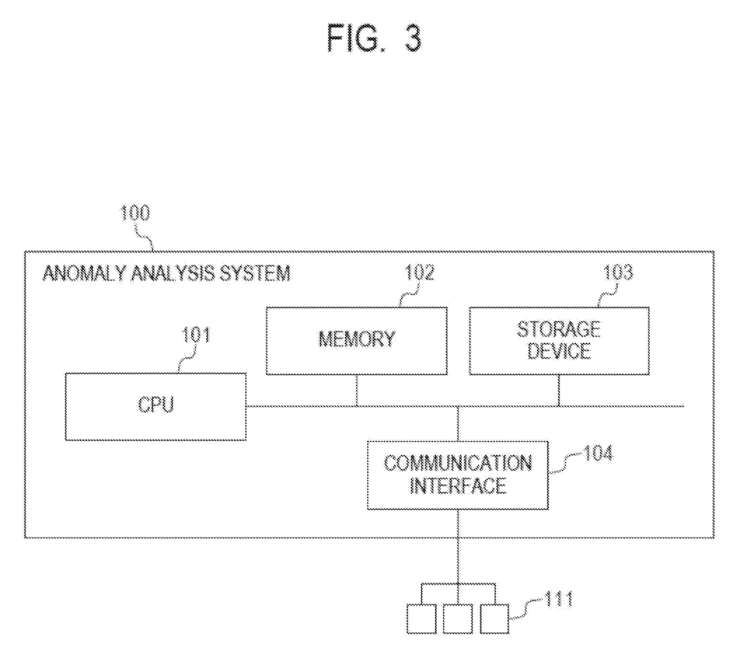

FIG. 3 is a general configuration diagram illustrating an exemplary device configuration of the anomaly analysis system 100 according to the present example embodiment. The anomaly analysis system 100 has a central processing unit (CPU) 101, a memory 102, a storage device 103, and a communication interface 104. The anomaly analysis system 100 may be an independent apparatus or may be configured integrally with another apparatus.

The communication interface 104 is a communication unit that transmits and receives data and is configured to be able to execute at least one of the communication schemes of wired communication and wireless communication. The communication interface 104 includes a processor, an electric circuit, an antenna, a connection terminal, or the like required for the above communication scheme. The communication interface 104 performs communication by using the communication scheme in accordance with a signal from the CPU 101. The communication interface 104 receives information that indicates the measurement values of the sensors 111 from the sensors 111, for example.

The storage device 103 stores a program executed by the anomaly analysis system 100, data of a process result obtained by the program, or the like. The storage device 103 includes a read only memory (ROM) dedicated to reading, a hard disk drive or a flash memory that is readable and writable, or the like. Further, the storage device 103 may include a computer readable portable storage medium such as a CD-ROM. The memory 102 includes a random access memory (RAM) or the like that temporarily stores data being processed by the CPU 101 or a program and data read from the storage device 103.

The CPU 101 is a processor as a processing unit that temporarily stores temporary data used for processing in the memory 102, reads a program stored in the storage device 103, and executes various processing operations such as calculation, control, determination, or the like on the temporary data in accordance with the program. Further, the CPU 101 stores data of a process result in the storage device 103 and also transmits data of the process result externally via the communication interface 104.

In the present example embodiment, the CPU 101 functions as the sensor value acquisition unit 110, the main-factor extraction unit 120, the sub-factor correction unit 130, the model output unit 140, and the anomaly analysis unit 150 of FIG. 2 by executing the program stored in the storage device 103. Further, in the present example embodiment, the storage device 103 functions as the sub-factor variable storage unit 161 and the model storage unit 162 of FIG. 2.

The anomaly analysis system 100 is not limited to the specific configuration illustrated in FIG. 3. The anomaly analysis system 100 is not limited to a single device and may be configured such that two or more physically separated devices are connected by wired or wireless connection. Respective units included in the anomaly analysis system 100 may be implemented by an electric circuitry, respectively. The electric circuitry here is a term conceptually including a single device, multiple devices, a chipset, or a cloud.

Further, at least a part of the anomaly analysis system 100 may be provided as a form of Software as a Service (SaaS). That is, at least some of the functions for implementing the anomaly analysis system 100 may be executed by software executed via a network.

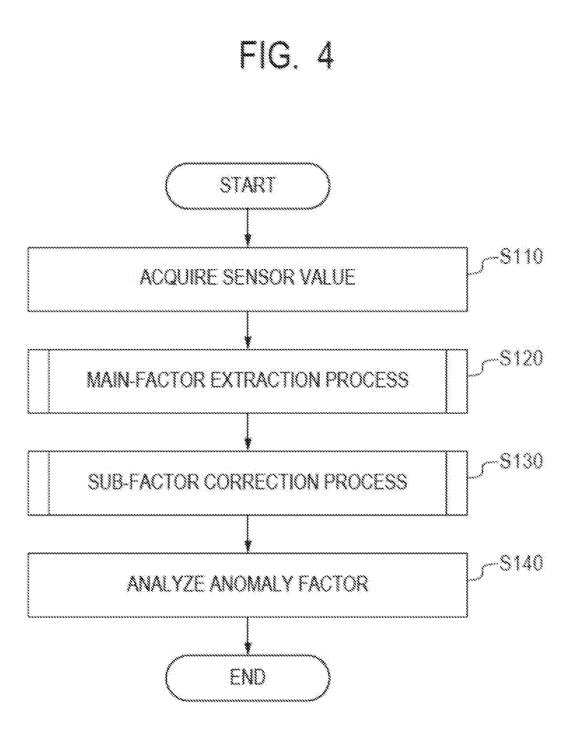

FIG. 4 is a diagram illustrating a flowchart of an anomaly analysis method by using the anomaly analysis system 100 according to the present example embodiment. The anomaly analysis method is started by the user performing a predetermined operation on the anomaly analysis system 100, for example.

First, the sensor value acquisition unit 110 acquires information indicating time-series measurement values (sensor values) measured by two or more sensors 111 provided in a facility to be analyzed (step S110). The sensors 111 that acquire sensor values in step S110 may be all of the sensors or some of the sensors designated as a target of anomaly analysis out of the sensors provided in a facility. The sensor value acquisition unit 110 may acquire sensor values from the sensors 111 via the communication interface 104 or may read and acquire sensor values stored in the memory 102 or the storage device 103 of the anomaly analysis system 100.

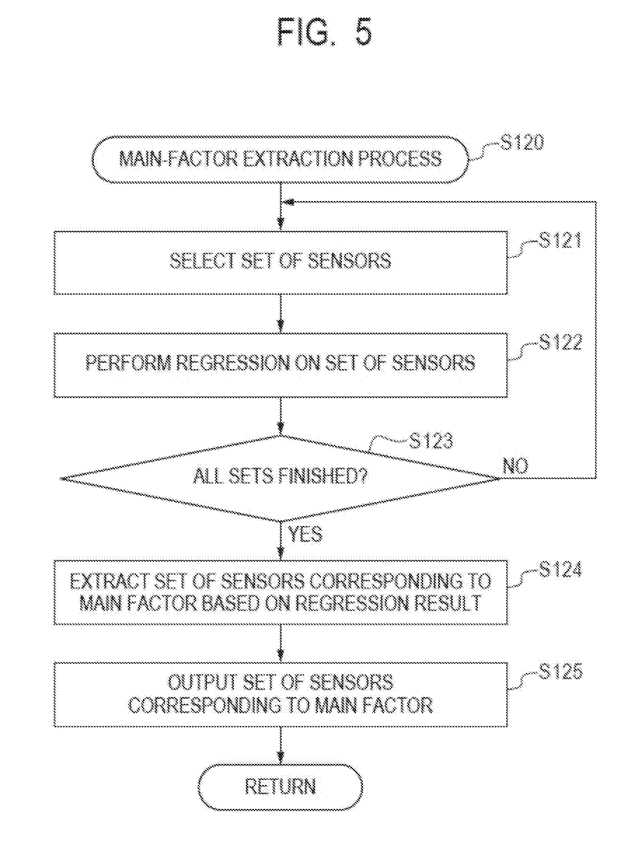

Next, the main-factor extraction unit 120 performs a main-factor extraction process described later by using FIG. 5 on the sensor values acquired in step S110 and thereby extracts one or more sets of sensors 111 as corresponding to a main factor (step S120). The set of sensors 111 extracted as corresponding to the main factor are stored in the memory 102 or the storage device 103.

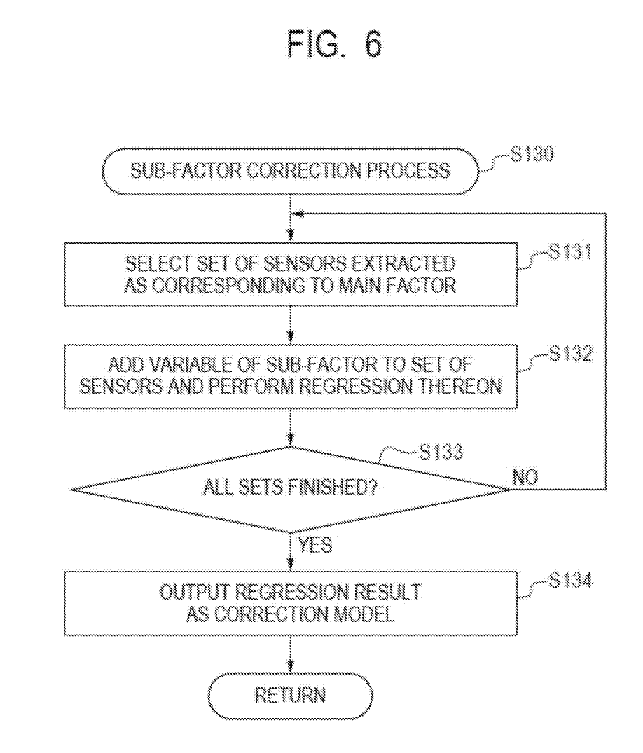

Next, the sub-factor correction unit 130 performs a sub-factor correction process described later by using FIG. 6 on the set of sensors 111 corresponding to a main factor extracted in step S120 and thereby generates a corrected model by using a sub-factor (step S130). The model corrected by using a sub-factor is stored in the model storage unit 162 as a correction model.

Finally, the anomaly analysis unit 150 compares sensor values acquired by the sensor value acquisition unit 110 with the correction model stored in the model storage unit 162 and thereby analyzes a factor related to an anomaly (step S140). A known method may be used for analysis of an anomaly factor by using a model.

While the anomaly factor analysis (step S140) is performed after the main-factor extraction process (step S120) and the sub-factor correction process (step S130) in a flowchart of FIG. 4, the start timing of the anomaly factor analysis may be set to any timing. For example, the anomaly factor analysis may be started in response to occurrence (or sign) of anomaly being detected as a trigger by a monitoring system or the like that is different from the present invention. Alternatively, the anomaly factor analysis may be started in response to a predetermined operation being performed as a trigger by the user on the anomaly analysis system 100.

FIG. 5 is a diagram illustrating the flowchart of the main-factor extraction process performed in the anomaly analysis system 100 according to the present example embodiment. The main-factor extraction process is performed in step S120 in a flowchart of FIG. 4.

First, the main-factor extraction unit 120 selects, out of the sensors 111 from which sensor values have been acquired, one set of two sensors 111 on which regression in step S122 has not yet been performed (step S121). Next, the main-factor extraction unit 120 performs regression on the set of sensors 111 selected in step S121 (step S122). For example, the least-squares method with an invariant model, that is, an Auto-Regressive with eXogenous input (ARX) model is used for regression. In the invariant model, anomaly analysis is performed by defining the relationship in a normal state (invariant relationship) between variables (between two sensors in this example) as a model and comparing the model with measurement values.

While not limited to a specific equation, the following Equation (1) is used to perform regression as an example.

[Math. 1]

yᵢ=aᵢxᵢ+bᵢ (1)

In equation (1), yᵢ is an objective variable, xᵢ is an explanatory variable, and aᵢ and bᵢ are regression coefficients. The index i is the number that identifies a set of the sensors 111. In the present example embodiment, a sensor value of one of the pair of sensors 111 is used as xᵢ, and a sensor value of the other sensor is used as yᵢ.

The main-factor extraction unit 120 performs regression on Equation (1) by using time-series sensor values acquired in step S110 and thereby calculates regression coefficients for the pair of sensors 111 selected in step S121.

If regression is not finished for all the sets of sensors 111 from which sensor values have been acquired in step S110 (step S123, NO), the process repeats steps S121 to S122 for the next set of sensors 111. If regression is finished for all the sets of sensors 111 from which sensor values have been acquired in step S110 (step S123, YES), the process proceeds to step S124. At this time, regression coefficients of Equation (1) have been calculated for all the sets of sensors 111 from which sensor values have been acquired in step S110.

The main-factor extraction unit 120 calculates an adaptation degree of regression from a regression result acquired in step S122. The main-factor extraction unit 120 then extracts one or more sets of sensors 111 considered as the main factor in accordance with the adaptation degree on each set of sensors 111 (step S124). In the present example embodiment, a determination coefficient (also referred to as a contribution rate) is used as an index representing an adaptation degree of regression.

While not limited to a specific equation, a determination coefficient R² is calculated from the following Equation (2), for example.

$$\begin{matrix}[ Math . 2 ] & \\ {R}^{2} = 1 - \frac{{\sum }_{j} {( {y}_{j} - {f}_{j} )}^{2}}{{\sum }_{j} {( {y}_{j} - Y )}^{2}} & ( 2 )\end{matrix}$$

In Equation (2), yⱼ is a measurement value, fⱼ is an estimation value from a regression equation, and Y is an averaged value of yⱼ. In the present example embodiment, a sensor value is used as yⱼ, and a regression result acquired in step S122 is used as fⱼ.

With respect to the determination coefficient R² calculated by Equation (2), a larger value thereof (that is, closer to 1) indicates that a regression result is more adapted to measurement values. Thus, the main-factor extraction unit 120 can use the determination coefficient R² as an adaptation degree. Other indices may be used without being limited to the determination coefficient R² as long as it can indicate the degree at which a regression result is adapted to measurement values.

The main-factor extraction unit 120 extracts, as corresponding to a main factor, one or more sets of sensors 111 having an adaptation degree that satisfies a predetermined criterion. As a specific extraction criterion, for example, all the sets whose adaptation degrees are greater than a predetermined value may be extracted as the sets corresponding to the main factor, or a predetermined number of sets in descending order of adaptation degree may be extracted as the sets corresponding to the main factor. Further, other extraction criteria by which one or more sets of sensors 111 having a high adaptation degree can be selected may be used.

The main-factor extraction unit 120 outputs the set of sensors 111 corresponding to the main factor extracted in step S124 (step S125). The set of sensor 111 extracted as the main factor is temporarily stored in the memory 102 or the storage device 103.

FIG. 6 is a diagram illustrating a flowchart of the sub-factor correction process performed in the anomaly analysis system 100 according to the present example embodiment. The sub-factor correction process is performed in step S130 in the flowchart of FIG. 4.

First, the sub-factor correction unit 130 selects one set including two sensors 111 on which regression has not yet been performed in step S132 out of the sets of sensors 111 extracted as corresponding to the main factor (step S131). Next, the sub-factor correction unit 130 adds a variable (value) indicating a sub-factor to the set of sensors 111 selected in step S131 and again performs regression thereon (step S132). The variable of the sub-factor is a factor that may exist in addition to the main factor and is desirably removed and that is measured in advance by a method different from the use of the sensors 111. The variable of the sub-factor in the present example embodiment is a fuel value indicating characteristics of fuel, which is measured by performing industry analysis or the like on the fuel in advance and stored in the sub-factor variable storage unit 161 as time-series data. The type of fuel value may be, for example, an element content of hydrogen, carbon, nitrogen, oxygen, sulfur, or the like in the fuel, a moisture, a hygroscopic moisture, a calorific value, a grindability, a fuel ratio, or the like. The same method as in the main-factor extraction process may be used as a method of regression.

While not limited to a specific equation, the following Equation (3) is used to perform regression as an example.

[Math. 3]

yₖ=aₖxₖ+bₖ+Σₗcₖₗzₗ (3)

In Equation (3), yₖ is an objective variable, xₖ is an explanatory variable of a main factor, zₗ is an explanatory variable of a sub-factor, aₖ, bₖ, and cₖₗ are regression coefficients. The index k is the number that identifies a set of the sensors 111. In the present example embodiment, a sensor value of one of the pair of sensors 111 is used as xₖ, and a sensor value of the other is used as yₖ. The value zₗ is each type of fuel values (a moisture, a hygroscopic moisture, a calorific value, or the like) that is a variable indicating a sub-factor, the index l is the number that identifies the type of fuel values.

The sub-factor correction unit 130 performs regression on Equation (3) by using the time-series sensor value acquired in step S110 and the variable indicating the sub-factor read from the sub-factor variable storage unit 161 and thereby calculates regression coefficients for the set of sensors 111 selected in step S131. By adding a variable indicating the sub-factor to a variable indicating the main factor previously extracted and performing regression thereon as discussed above, a regression result corrected by the variable indicating the sub-factor is obtained.

If regression has not been finished for all the sets of sensors 111 extracted as corresponding to the main factor (step S133, NO), the process repeats steps S131 to S132 for the next set of sensors 111. If regression has been finished for all the sets of sensors 111 extracted as corresponding to the main factor (step S133, YES), the process proceeds to step S134. At this time, regression coefficients of Equation (3) have been calculated for all the sets of sensors 111 extracted as corresponding to the main factor.

The sub-factor correction unit 130 outputs, as a correction model, a regression result corrected by a variable indicating a sub-factor in step S132 (step S134). The correction model is stored in the model storage unit 162 and used for anomaly analysis.

A known scheme of selecting variables may be applied to Equation (3). For example, with a use of L1 normalization as a scheme of selecting variables, a regression coefficient (cₖₗ), which is a term less influencing regression, can be zero. If there is a term that less influences regression, an error due to excessive estimation may occur. That is, this results in excessive adaptation to learning data in which there are many terms that less influence regression in model construction, estimation accuracy is likely to decrease with respect to other data. In contrast, by applying a scheme of selecting variables to reduce a term having a small influence on regression to zero, it is possible to suppress excessive estimation to improve estimation accuracy. Further, although a calculation amount increases when the number of explanatory variables of the sub-factor is larger in Equation (3), the number of explanatory variables can be reduced by application of such a scheme of selecting variables, and thus the calculation amount can be reduced.

The CPU 101 of the anomaly analysis system 100 is a subject of each step (operation) included in the process illustrated in FIG. 4 to FIG. 6 in the present example embodiment. That is, the CPU 101 performs the process illustrated in FIG. 4 to FIG. 6 by reading the program used for executing the process illustrated in FIG. 4 to FIG. 6 from the memory 102 or the storage device 103 and executing the program to control each unit of the anomaly analysis system 100. Further, at least a part of the process illustrated in FIG. 4 to FIG. 6 may be performed by a dedicated device or an electric circuit instead of the CPU 101.

While the relationship between two sensors 111 (that is, the invariant model) is used for extraction of a main factor performed by the main-factor extraction unit 120 in the present example embodiment, the example embodiment is not limited thereto as along as a main factor can be extracted by using sensor values. For example, a single sensor 111 may be used for extraction of a main factor. In such a case, self-regressive model of the single sensor 111, that is, an Auto-Regressive (AR) model is used for regression. The main factor extraction unit 120 can calculate the adaptation degree of each sensor 111 from a regression result using a self-regressive model and extract one or more sensors 111 considered as a main factor in accordance with the adaptation degree.

While a fuel value is used as a variable indicating a sub-factor in the present example embodiment, other values indicating a factor that may exist in addition to a main factor and is desirably removed may be used. For example, the atmospheric temperature or the atmospheric pressure may be used as a variable indicating a sub-factor. This is because, although the atmospheric temperature or the atmospheric pressure may change a tendency of sensor values due to the seasonal variation, the atmospheric temperature or the atmospheric pressure is often not a direct cause of an anomaly. Since application of the present example embodiment can remove an influence of the atmospheric temperature or the atmospheric pressure on the sensor value, analysis of a true factor of an anomaly is facilitated.

The anomaly analysis system 100 according to the present example embodiment extracts a main factor by using regression, then adds a variable indicating a sub-factor and again performs regression thereon, and thereby generates a model corrected by a sub-factor. With such a configuration, since a model can be obtained by taking the influence of a sub-factor, which is different from a main factor, into consideration, determination of a true factor can be facilitated in anomaly analysis. Further, since the anomaly analysis system 100 can perform analysis by only acquiring time-series information of a sub-factor together with sensor values, it is not necessary to perform numerical analysis based on design and operation conditions of a plant or the like, and this results in less labor in introduction.

### Other Example Embodiments

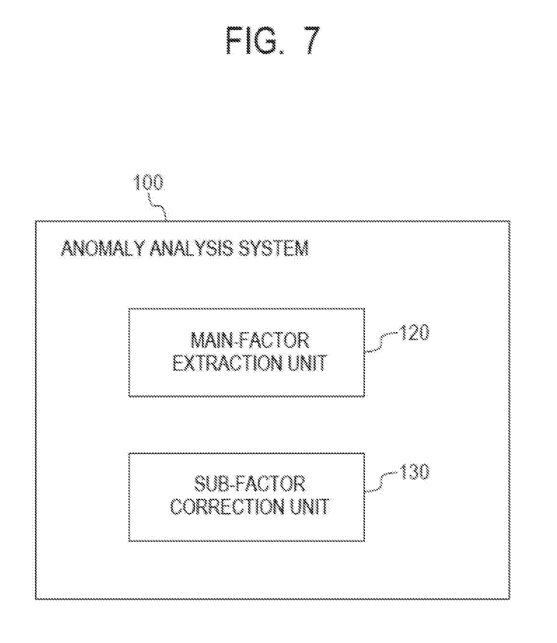

FIG. 7 is a block diagram of the anomaly analysis system 100 according to each example embodiment described above. FIG. 7 illustrates a configuration example by which the anomaly analysis system 100 functions as a device that extracts a main factor from a measurement value of a sensor and further generates a model corrected by using a value indicating a sub-factor in addition to a value indicating the main factor. The anomaly analysis system 100 includes the main-factor extraction unit 120 that, based on measurement values measured by a plurality of sensors provided in a facility, extracts a sensor corresponding to a main factor that influences the measurement values and a sub-factor correction unit 130 that generates a model indicating a normal state of the facility by using a value indicating a sub-factor that influences the measurement values in addition to the measurement values measured by the sensors corresponding to the main factor, and the value indicating the sub-factor is measured by a scheme different from a use of the sensors.

The present invention is not limited to the example embodiments described above and can be changed without departing from the spirit of the present invention.

Further, the scope of each of the example embodiments includes a processing method that stores, in a storage medium, a program that causes the configuration of each of the example embodiments to operate so as to implement the function of each of the example embodiments described above (more specifically, a log analysis program that causes a computer to perform the process illustrated in FIG. 4 to FIG. 6), reads the program stored in the storage medium as a code, and executes the program in a computer. That is, the scope of each of the example embodiments also includes a computer readable storage medium. Further, each of the example embodiments includes not only the storage medium in which the program described above is stored but also the program itself.

As the storage medium, for example, a floppy (registered trademark) disk, a hard disk, an optical disk, a magneto-optical disk, a CD-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary Note 1)

An anomaly analysis method comprising steps of:

based on measurement values measured by a plurality of sensors provided in a facility, extracting a sensor corresponding to a main factor that influences the measurement values; and

generating a model indicating a normal state of the facility by using a value indicating a sub-factor that influences the measurement values in addition to the measurement values measured by the sensors corresponding to the main factor,

wherein the value indicating the sub-factor is measured by a scheme different from the sensors.

(Supplementary Note 2)

The anomaly analysis method according to supplementary note 1,

wherein the step of extracting the main factor extracts a set of the sensors corresponding to the main factor based on the measurement values of a set of the sensors the number of which is two, and

wherein the step of generating the model generates the model by using the measurement values measured by the set of the sensors corresponding to the main factor.

(Supplementary Note 3)

The anomaly analysis method according to supplementary note 1 or 2, wherein the step of extracting the main factor extracts the sensors corresponding to the main factor by performing regression on the measurement values.

(Supplementary Note 4)

The anomaly analysis method according to supplementary note 3, wherein the step of extracting the main factor performs the regression by using the measurement values as explanatory variables.

(Supplementary Note 5)

The anomaly analysis method according to supplementary note 3 or 4, wherein the step of extracting the main factor extracts the sensors corresponding to the main factor in accordance with an adaptation degree of the regression.

(Supplementary Note 6)

The anomaly analysis method according to any one of supplementary notes 1 to 5, wherein the step of generating the model generates the model by performing regression on the measurement values measured by the sensors corresponding to the main factor and the value indicating the sub-factor.

(Supplementary Note 7)

The anomaly analysis method according to supplementary note 6, wherein the step of generating the model performs the regression by using the measurement values measured by the sensors corresponding to the main factor and the value indicating the sub-factor as explanatory variables.

(Supplementary Note 8)

The anomaly analysis method according to any one of supplementary notes 1 to 7, wherein the value indicating the sub-factor is a value indicating characteristics of fuel used for operating the facility.

(Supplementary Note 9)

The anomaly analysis method according to any one of supplementary notes 1 to 8 further comprising a step of performing anomaly analysis based on the measurement values and the model.

(Supplementary Note 10)

An anomaly analysis program that causes a computer to perform steps of:

based on measurement values measured by a plurality of sensors provided in a facility, extracting a sensor corresponding to a main factor that influences the measurement values; and

generating a model indicating a normal state of the facility by using a value indicating a sub-factor that influences the measurement values in addition to the measurement values measured by the sensors corresponding to the main factor,

wherein the value indicating the sub-factor is measured by a scheme different from the sensors.

(Supplementary Note 11)

An anomaly analysis system comprising:

a main-factor extraction unit that, based on measurement values measured by a plurality of sensors provided in a facility, extracts a sensor corresponding to a main factor that influences the measurement values; and

a sub-factor correction unit that generates a model indicating a normal state of the facility by using a value indicating a sub-factor that influences the measurement values in addition to the measurement values measured by the sensors corresponding to the main factor,

wherein the value indicating the sub-factor is measured by a scheme different from the sensors.

What is claimed is:

1. An anomaly analysis method comprising steps of:
based on measurement values measured by a plurality of sensors provided in a facility, extracting a sensor corresponding to a main factor that influences the measurement values; and
generating a model indicating a normal state of the facility by using a value indicating a sub-factor that influences the measurement values in addition to the measurement values measured by the sensors corresponding to the main factor,
wherein the value indicating the sub-factor is measured by a scheme different from the sensors.

2. The anomaly analysis method according to claim 1,
wherein the step of extracting the main factor extracts a set of the sensors corresponding to the main factor based on the measurement values of a set of the sensors the number of which is two, and
wherein the step of generating the model generates the model by using the measurement values measured by the set of the sensors corresponding to the main factor.

3. The anomaly analysis method according to claim 1, wherein the step of extracting the main factor extracts the sensors corresponding to the main factor by performing regression on the measurement values.

4. The anomaly analysis method according to claim 3, wherein the step of extracting the main factor performs the regression by using the measurement values as explanatory variables.

5. The anomaly analysis method according to claim 3, wherein the step of extracting the main factor extracts the sensors corresponding to the main factor in accordance with an adaptation degree of the regression.

6. The anomaly analysis method according to claim 1, wherein the step of generating the model generates the model by performing regression on the measurement values measured by the sensors corresponding to the main factor and the value indicating the sub-factor.

7. The anomaly analysis method according to claim 6, wherein the step of generating the model performs the regression by using the measurement values measured by the sensors corresponding to the main factor and the value indicating the sub-factor as explanatory variables.

8. The anomaly analysis method according to claim 1, wherein the value indicating the sub-factor is a value indicating characteristics of fuel used for operating the facility.

9. The anomaly analysis method according to claim 1 further comprising a step of performing anomaly analysis based on the measurement values and the model.

10. A non-transitory storage medium in which an anomaly analysis program is stored, the program that causes a computer to perform:
based on measurement values measured by a plurality of sensors provided in a facility, extracting a sensor corresponding to a main factor that influences the measurement values; and
generating a model indicating a normal state of the facility by using a value indicating a sub-factor that influences the measurement values in addition to the measurement values measured by the sensors corresponding to the main factor,
wherein the value indicating the sub-factor is measured by a scheme different from the sensors.

11. An anomaly analysis system comprising:
a main-factor extraction unit that, based on measurement values measured by a plurality of sensors provided in a facility, extracts a sensor corresponding to a main factor that influences the measurement values; and
a sub-factor correction unit that generates a model indicating a normal state of the facility by using a value indicating a sub-factor that influences the measurement values in addition to the measurement values measured by the sensors corresponding to the main factor,
wherein the value indicating the sub-factor is measured by a scheme different from the sensors.
